(19) United States
(12) Patent Application Publication
(10) Pub. No.: US 2008/0135070 A1
(43) Pub. Date: Jun. 12, 2008

(54) METHOD AND APPARATUS FOR ACTIVE PARTICLE AND CONTAMINANT REMOVAL IN WET CLEAN PROCESSES IN SEMICONDUCTOR MANUFACTURING

(76) Inventors: Wei Lu, Fremont, CA (US); Jianshe Tang, San Jose, CA (US); Alexander Sou-Kang Ko, Santa Clara, CA (US); Nelson A. Yee, Redwood City, CA (US); Bo Xie, Sunnyvale, CA (US); Tseng-Chung Lee, San Jose, CA (US)

Correspondence Address: APPLIED MATERIALS/BLAKELY, 1279 OAKMEAD PARKWAY, SUNNYVALE, CA, 94085-4040, US

(21) Appl. No.: 11/609,843

(22) Filed: Dec. 12, 2006

(51) Int. Cl. B08B 3/02

(52) U.S. Cl. 134/103.2

(57) ABSTRACT

An apparatus and a method for cleaning a wafer are described. A chamber has a substrate support. A nozzle is disposed above the substrate support to spray de-ionized water droplets. The nozzle is coupled to a source of de-ionized water and a source of nitrogen. The nozzle is configured to mix the de-ionized water and the nitrogen outside the nozzle to have independent flow rate control of the two fluids for an optimized atomization in terms of spray uniformity in droplet size and velocity distributions. The nozzle to wafer distance can be adjusted and tuned to have an optimized jet spray for efficiently removing particles or contaminants from a surface of a wafer without causing any feature damage.

### TECHNICAL FIELD

This invention relates to the field of wafer cleaning and, in particular, to deionized water droplets for wafer cleaning.

### BACKGROUND

For fabrication of semiconductor devices, thin slices or wafers of semiconductor material require polishing by a process that applies an abrasive slurry to the wafer's surfaces. After polishing, slurry residue is generally cleaned or scrubbed from the wafer surfaces via mechanical scrubbing devices. A similar polishing step is performed to planarize dielectric or metal films during subsequent device processing on the semiconductor wafer.

After polishing, be it during wafer or device processing, slurry residue conventionally is cleaned from wafer surfaces by submersing the wafer into a tank of sonically energized cleaning fluid, by spraying with sonically energized cleaning or rinsing fluid, by mechanically cleaning the wafer in a scrubbing device which employs brushes, such as polyvinyl acetate (PVA) brushes, or by a combination of the foregoing.

Although these conventional cleaning devices remove a substantial portion of the slurry residue which adheres to the wafer surfaces, slurry particles nonetheless remain and may produce defects during subsequent processing. Specifically, subsequent processing has been found to redistribute slurry residue from the wafer's edges to the front of the wafer, causing defects. Furthermore, these conventional cleaning devices may cause additional damage of devices on the wafer.

Particles or other contaminants may also be deposited onto the wafer surface as particle excursions during other process flow such as, film deposition and etch. Rather than stopping the process flow to troubleshoot and fix particle issues when they are observed, a nondestructive rinse and clean step is generally used for every wafer running through the process flow, in order to address and remove those potential particles to prevent interruption of the process flow.

### BRIEF DESCRIPTION OF THE DRAWINGS

The present invention is illustrated by way of example, and not by way of limitation, in the figures of the accompanying drawings.

FIG. 1 is a schematic diagram illustrating a conventional nozzle for cleaning a wafer.

FIG. 2 is a schematic diagram illustrating one embodiment of an apparatus for cleaning a wafer.

FIG. 3 is a schematic diagram illustrating one embodiment of a nozzle for cleaning a wafer.

FIG. 4 is a schematic diagram illustrating a cross-sectional view of a nozzle for cleaning a wafer.

FIG. 5 is a schematic diagram illustrating a transversal cross-sectional view of a nozzle for cleaning a wafer.

FIG. 6 is a schematic diagram illustrating a perspective view of a nozzle for cleaning a wafer.

FIG. 7 is a schematic diagram illustrating different spray patterns from the nozzle.

FIG. 8 is a schematic diagram illustrating one embodiment of a spray pattern for cleaning a wafer.

FIG. 9 is a flow diagram of a method for cleaning a wafer in accordance with one embodiment.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of the present invention.

A method and apparatus for cleaning a wafer is described. A chamber has a substrate support supporting a wafer. A nozzle is disposed above the substrate support to spray de-ionized water droplets on the wafer. The nozzle is coupled to a source of de-ionized water and a source of nitrogen. The nozzle is configured to mix the de-ionized water and the nitrogen outside the nozzle.

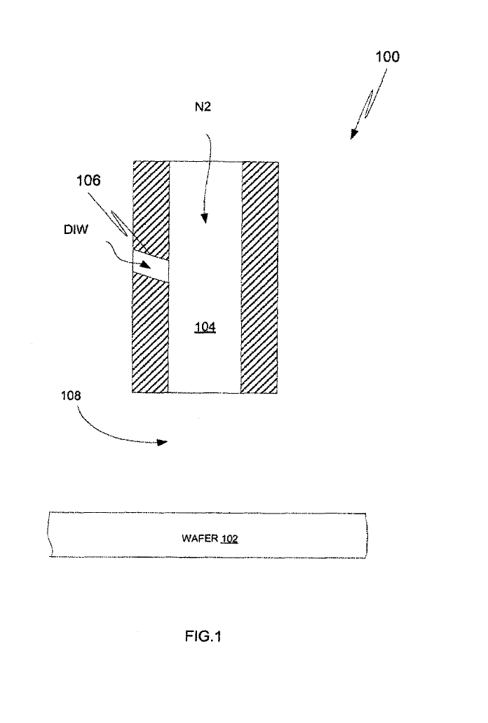

FIG. 1 is a schematic diagram illustrating a conventional nozzle used for cleaning a wafer 102. The nozzle 100 includes a main chamber 104. Nitrogen gas is injected in the main chamber 104. De-ionized water (DIW) is injected in the main chamber 104 via a conduit 106, and as a result the flows of two fluids cannot be adjusted independently. The DIW and the nitrogen gas are mixed internally in the main chamber 104. A spray 108 is generated onto the surface of the wafer 102. Although the spray may be sufficient to clean the surface of the wafer 102, it may also cause damage to the surface features of the wafer 102. On the other hand, a non-effective spray may not cause damage to surface features of the wafer 102, but may not be effective in removing all or a substantial amount of contaminants on the surface of the wafer 102.

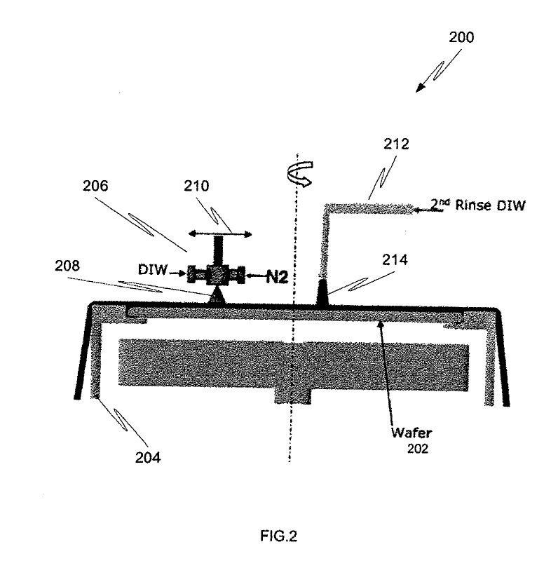

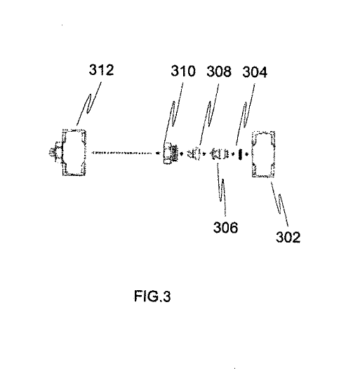

FIG. 2 illustrates an apparatus 200 for cleaning a wafer 202. A substrate support 204 supports the wafer 202. The substrate support 204 is capable of spinning as further described below. A first nozzle 206 is disposed above the wafer 202. The first nozzle 206 sprays atomized de-ionized water droplets 208 to actively remove particles or contaminants from the wafer 202 without damaging surface features of the wafer 202. The first nozzle 206 may move in along a planar axis 210 above the wafer 202. The de-ionized water and the nitrogen gas are fed into the first nozzle 206. The first nozzle 206 is described in more detail with respect to FIGS. 3, 4, and 5.

In accordance with another embodiment, a second nozzle 212 may be disposed off-center from the center of the wafer 202 to spray de-ionized water 214 for a second rinse. For example, the wafer 202 may be spinning at 750 rpm. The second nozzle 212 may have a rinse flow rate of about 800 to about 2000 ml/min. The second nozzle 212 may dispense at a location for example, about 20 mm, off-center of the wafer 202.

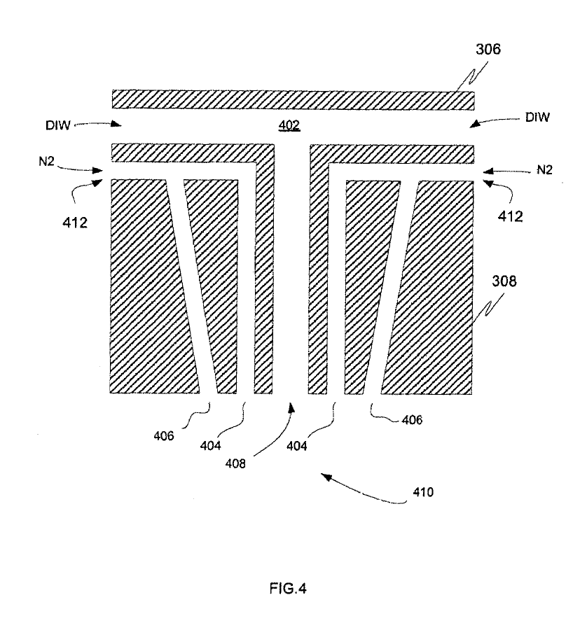

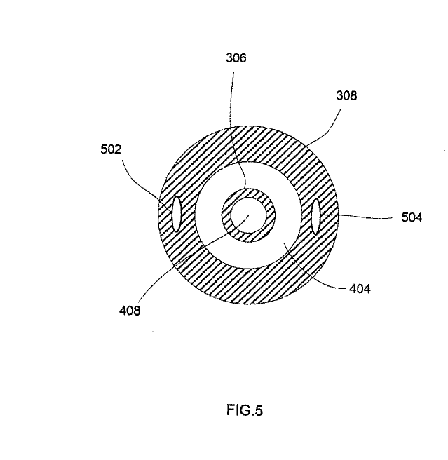

FIG. 3 illustrates one embodiment of a nozzle. A nozzle body 302 is coupled to a fluid cap 306 with an O-ring 304. The fluid cap 306 is combined with an air cap 308. A retainer ring 310 couples the air cap 308, the fluid cap 306, and the O-ring 304 with the nozzle body 302 to form the assembled nozzle 312. The fluid cap 306 provides a conduit and passageway for a fluid, such as de-ionized water. The air cap 308 provides a conduit and passageway for a gas, such nitrogen gas. A cross-sectional view of the fluid cap 306 and the air cap 306 is illustrated in FIGS. 4-5.

FIG. 4 illustrates a cross-sectional view of one embodiment of the air cap 308 and the fluid cap 306 of nozzle 312. A source of de-ionized water (not shown) provides de-ionized water to the fluid cap 306. A source of nitrogen gas (not shown) provides nitrogen gas to the gas cap 308.

The fluid cap 306 includes a main channel 402 formed through a center of the fluid cap 306 and includes an aperture 408 in a central region at an end of the nozzle 312. The gas cap 308 includes two channels 404, 406 through which the gas may travel. In particular, channel 404 may be adjacent to the main channel 402 of the fluid cap 306. Channel 406 may be formed peripherally adjacent to channel 404. Those of ordinary skills in the art will recognize that the gas cap 308 may include a number of channel to further facilitate atomization of the de-ionized water.

In accordance with one embodiment, the nitrogen gas is introduced in the nozzle 312 through the main channel 402. The de-ionized water is introduced in the nozzle 312 through channel 412. The nitrogen gas and de-ionized water are mixed outside the nozzle 312 at room temperature. Those of ordinary skills in the art will recognize that the nitrogen gas and the de-ionized water may be introduced and mixed at other different temperatures.

The nitrogen gas output by channels 404, 406 is mixed with the output of the aperture 408 at an external mixing region 410 outside the nozzle 312 to generate atomized de-ionized water droplets. The external mixing region 410 may be below the nozzle 312 and above the surface of the wafer.

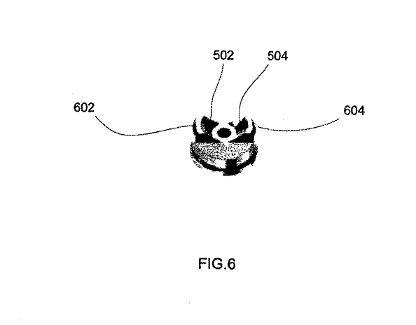

FIG. 5 illustrates a bottom view cross-sectional view of the nozzle 312. The aperture 408 is formed in the center at the end of the nozzle 312. In one embodiment, the aperture 408 is circular. In other embodiments, the aperture 408 may have different shapes such as oval, rectangular, and others. Channel 404 may be formed as a concentric circle adjacent to the main aperture 408. Channel 404 may also have many other shapes. In accordance with one embodiment, channel 406 may be disposed peripherally adjacent to channel 408 to form two outlets 502, 504. Outlets 502, 504 are used to define the shape of jet spray, such as different spray pattern and envelop spray angle (e.g, 50, 65, or 90 degrees). Outlets 502, 504 may further atomize the de-ionized water and may also have many other shapes. FIG. 6 illustrates a perspective view of the nozzle 312. Outlets 502, 504 are located on protruded notches 602, 604 respectively.

In accordance with another embodiment, channel 406 may form several outlets outside the nozzle 312 to further atomize the de-ionized water.

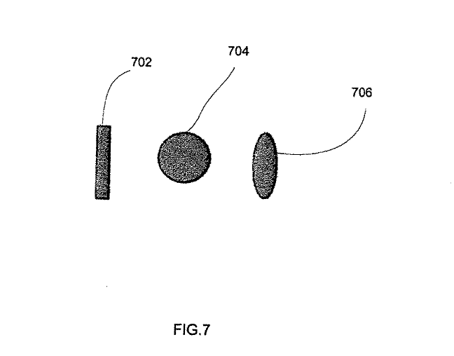

FIG. 7 illustrates various spray patterns of the nozzle 312. For example, nozzle 312 may produce a flat pattern 702, a round pattern 704, or an elliptical pattern 706. Those of ordinary skills in the art will recognize that the nozzle may spray many other patterns suitable for cleaning a wafer.

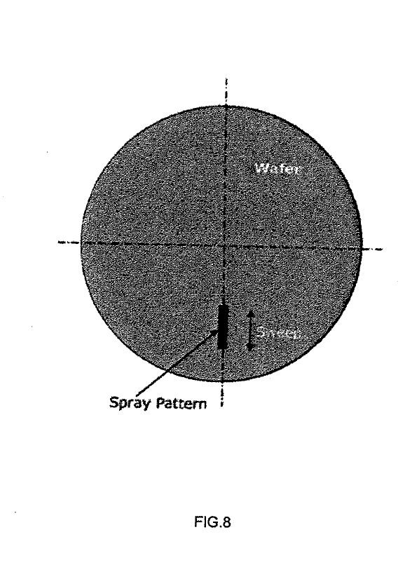

FIG. 8 illustrates an embodiment of a sweeping of a spray pattern on a wafer. In accordance with one embodiment, the wafer may be spinning at about 750 rpm. The nozzle may be swept initially from the edge of the wafer to the center of the wafer at a sweep rate of about 2 sweeps per minute at a specifically designed sweep profile to get uniform exposure to the spray for every surface area. The nozzle spray orientation during a wafer cleaning is illustrated in FIG. 8. The larger spray pattern dimension along a radial direction of the wafer is used to maximize efficiency.

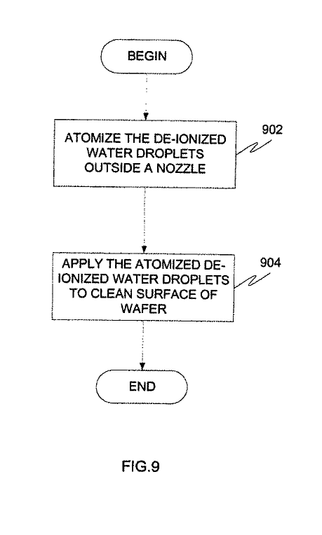

FIG. 9 is a flow diagram of a method for cleaning a wafer in accordance with one embodiment. At 902, de-ionized water droplets are atomized outsize a nozzle as previously described. At 904, the atomized de-ionized water droplets are applied to clean the surface of the wafer without damaging its features. In accordance with one embodiment, the nozzle may spray at different angles (e.g, 50, 60, or 90 degrees).

The spacing between the nozzle and the wafer surface to be cleaned may be within a range of about 15 mm to about 100 mm, while conventional spacing ranges for such nozzle in the targeted applications are typically far over 150 mm. The distance between the nozzle and the wafer surface is adjusted for an optimized jet spray such that the spray is able to efficiently remove particles or contaminants without causing any feature damage.

In accordance with one embodiment, the nitrogen gas flow rate may be in a range of about 20 to about 180 SCFH at a pressure of about 70 psi for external-mix nozzles. In contrast, a conventional nitrogen gas flow rate may be in a range of 140 to 450 SCFH with a pressure of 25 to 30 psi.

The presently described nozzle can generate a highly uniform water jet spray, in terms of droplet size and flying velocity, with a characteristic velocity distribution along the distance that the spray travels, to actively remove particles or contaminants. The characteristic velocity distribution can be tuned for different cleaning applications, such as FEOL and BEOL wafer cleaning and wafer bevel cleaning.

Under the previously described conditions, a water jet spray with highly tight kinetic energy distribution and adjustable peak energy may be achieved by tuning the nozzle-wafer spacing. The kinetic energy distribution and the peak energy are critical for a high removal efficiency (>90%) of particles or contamination without any feature damage.

The kinetic energy of the droplets may be expressed with the following equation:

Eₖ=½×m×v²

wherein Eₖ is the Kinetic Energy, m is the mass of the droplet, and v is velocity of the droplet.

The Power density of the droplets may be expressed with the following equation:

P=Eₖ×(Q/(⅙×π×d³))

wherein Q is the volume flux.

Thus, the power density can be maintained by reducing the size of the droplets and increasing the velocity of the droplets. The smaller droplets size prevents any line damages to the wafer. The faster droplets efficiently clean the wafer without damaging its surface.

In accordance with another embodiment, a surface tension reducing agent, such as a surfactant, may be used to reduce the de-ionized water surface tension, so that nitrogen mixing can fully atomize the de-ionized water. The present invention is not solely limited to de-ionized water. Those of ordinary skills in the art will recognize that other chemical solutions may be used to replace the de-ionized water to form an atomized chemical spray to enhance the particle or contaminants removal efficiency in the cleaning process.

In accordance with another embodiment, the de-ionized water supplied to the nozzle can be heated to reduce the de-ionized water surface tension, so that nitrogen mixing can fully atomize the de-ionized water.

In accordance with another embodiment, one or more of the above means for atomizing the de-ionized water can be combined to produce de-ionized water droplets of a smaller size.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. An apparatus for cleaning a wafer comprising:
a chamber having a substrate support therein; and
a nozzle disposed above the substrate support to spray de-ionized water droplets, the nozzle coupled to a source of de-ionized water and a source of nitrogen, the nozzle configured to mix the de-ionized water and the nitrogen outside the nozzle.

2. The apparatus of claim 1 wherein the nozzle comprises:
a nozzle body;
a fluid cap coupled to the nozzle body;
an air cap coupled to the fluid cap; and
a retainer ring coupled to the air cap.

3. The apparatus of claim 2 wherein the fluid cap comprises a first conduit for the de-ionized water, and the air cap comprises a second conduit for the nitrogen, the first and second conduit being separate from each other, the de-ionized water and the nitrogen externally mixed adjacent to the retainer ring.

4. The apparatus of claim 2 wherein the air cap comprises a first conduit, a second conduit, and a third conduit, the first conduit concentric to a channel of the fluid cap, the second and third conduits oppositely adjacent to the channel of the fluid cap.

5. The apparatus of claim 4 wherein an axis of the second conduit intersects an axis of the third conduit along an axis of the channel.

6. The apparatus of claim 1 wherein the nozzle is to produce an atomized spray having configurable patterns.

7. The apparatus of claim 1 wherein the nozzle is disposed above a surface of a wafer to be cleaned at a distance from about 15 mm to about 100 mm.

8. The apparatus of claim 1 wherein the nozzle is to produce an atomized spray at an angle relative to the substrate support.

9. The apparatus of claim 1 wherein the source of nitrogen has a flow rate of about 20 to about 180 SCFH at a pressure of about 70 psi.

10. The apparatus of claim 1 wherein the substrate support is configured to spin at 750 rpm.

11. The apparatus of claim 10 further comprising a second nozzle disposed above the substrate support off a center of the substrate support, the second nozzle to dispense a second de-ionized water.

12-20. (canceled)
